(19) United States
(12) Patent Application Publication
(10) Pub. No.: US 2007/0226097 A1
(43) Pub. Date: Sep. 27, 2007

(54) Merchant integrated subscription model

(76) Inventor: Alexander J. Keechle, Irving, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/389,108

(22) Filed: Mar. 27, 2006

(51) Int. Cl. G06Q 40/00

(52) U.S. Cl. 705/35

(57) ABSTRACT

A system, method, and computer program product for integrating one or more purchase transactions by one or more customers with a merchant and a financial institution is provided. A financial institution may provide an integrated subscription service to subscribing merchants. The integrated subscription service allows the merchant, financial institution, or another party to select a marketing plan for the merchant in order to attract customers. Those customers may then use a financial account of the financial institution to aid in the purchase of goods and/or services from the merchant. The financial institution may then compensate the merchant for these purchase transactions.

### DESCRIPTION OF THE INVENTION

1. Field of the Invention

The present invention relates to methods and systems for providing financial services, and more particularly for providing incentives to merchants to use a particular financial institution for financial services.

2. Background of the Invention

Automobile purchases are typically one of the larger purchases for an average consumer. Therefore, consumers often look to a bank or other financial institution to obtain financing for purchasing an automobile. To lure consumers to their dealerships, automobile dealers will often advertise automobile loans that are backed by a financial institution. However, there is no mechanism in place to encourage the dealers to actually use these loan arrangements when a consumer decides to purchase an automobile from the dealership. In fact, most financial institutions charge a fee for each loan they extend to a dealer's customer. This creates a disincentive for dealers to use the financial institution's advertised financial services and causes many dealers to “flip” the loan to another lender or bank. Accordingly, there is a need for a mechanism that encourages a dealer to secure loans associated with a purchase transaction using the financial services of an advertised financial institution, rather than flipping the loans to third party lenders.

### SUMMARY OF THE INVENTION

In one embodiment, a method is disclosed for providing integrated subscription services. The method may include subscribing, by a merchant, to an integrated subscription plan offered by a financial institution that provides an incentive to the merchant for using a financial service offered by the financial institution in completing purchase transactions. Further, the method may include marketing, by the financial institution, the merchant to one or more potential customers based on the integrated subscription plan. A purchase transaction may be completed between a first customer and the merchant. In one embodiment, the first customer is included in the one or more potential customers and the purchase transaction is completed using a financial account offered by the financial institution. Based on the completed purchase transaction, the financial institution may provide compensation to the merchant.

In another embodiment, a system is provided for integrating one or more purchase transactions by one or more customers with a merchant and a financial institution. The system may include a host computer system and a storage unit associated with the host computer system. The storage unit may be configured to store at least an indication of the merchant's subscription to an integrated subscription plan offered by the financial institution and an indication of one or more completed purchase transactions between a first customer and the merchant for one or more goods or services offered by the merchant. Further, the system may include a distribution unit associated with the host computer system. The distribution unit may be configured to distribute marketing information from the financial institution to one or more potential customers. The marketing information may market the merchant to the one or more potential customers. Further, the first customer may be included in the one or more potential customers and the one or more completed purchase transactions may be made using one or more financial services offered by the financial institution. Based on the one or more completed purchase transactions, the financial institution may provide compensation to the merchant.

In another embodiment, a computer program product embodied in a computer-readable medium is disclosed. The computer program product may perform, when executed by a processor, a method for integrating one or more purchase transactions by one or more customers with a merchant and a financial institution. The computer program product may include a first program code portion executed by the processor to enable the merchant, to subscribe to an integrated subscription plan offered by the financial institution. Further, computer program product may include a second program code portion executed by the processor to enable the merchant to indicate to the financial institution to market the merchant to one or more potential customers. Also, the computer program product may include a third program code portion executed by the processor to indicate a completion of one or more purchase transactions between a first customer and the merchant for one or more goods or services offered by the merchant. The first customer may be included in the one or more potential customers and the one or more purchase transactions may be made using a financial service offered by the financial institution. The computer program product may also include a fourth program code portion executed by the processor to enable the financial institution to provide compensation to the merchant based on the one or more completed purchase transactions.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary integrated subscription system consistent with certain embodiments of the present invention;

FIG. 2 is an illustration of an exemplary database structure consistent with certain embodiments of the present invention;

FIG. 3 is a flow chart of an exemplary merchant incentive process consistent with certain embodiments of the present invention;

FIG. 4 is a flow chart of an exemplary subscription process consistent with certain embodiments of the present invention;

FIG. 5 is a flow chart of an exemplary refund process consistent with certain embodiments of the present invention; and

FIG. 6 is a flow chart of another exemplary merchant incentive process consistent with certain embodiments of the present invention.

### DETAILED DESCRIPTION

The following detailed description refers to the accompanying drawings. Wherever possible, the same reference numbers are used in the drawings and the following description when referring to the same or similar parts. While several exemplary embodiments and features of the invention are described herein, modifications, adaptations, and other implementations are possible without departing from the spirit and scope of the invention. Accordingly, the following detailed description does not limit the invention. Instead, the proper scope of the invention is defined by the appended claims.

The phrase “and/or” as used in this application with regard to a list of items means that any one of the items may constitute the described group of items or alternatively any combination of the items may constitute the described group.

Systems and methods consistent with certain embodiments related to the present invention provide incentives for a merchant to select a particular financial institution to finance its customers' purchases. The disclosed embodiments may be implemented in various environments, including computer-based environments that use, for example, personal computers, workstations, servers, laptops, personal digital assistants (PDAs), mobile phones, handheld devices, and the like. The disclosed embodiments may also be implemented using other types of electronic and non-electronic environments, such as, for example, postal mail, radio, and television systems and/or infrastructures. The present invention, however, is not limited to such examples, and embodiments consistent with the present invention may be implemented using other types of environments, platforms, and/or infrastructures.

The storage media referred to herein symbolize elements that temporarily or permanently store data and instructions. The storage functions associated with the disclosed embodiments of the present invention may be implemented via a computer, portions of a computer, a processor, a computer network, and any other component and medium capable of storing information. For example, various types of storage media may be used to store information associated with the embodiments of the present invention, such as read-only memory (ROM), random access memory (RAM), and any other type of memory. Further, the storage functions associated with the disclosed embodiments may be physically implemented by computer-readable media, such as, for example (a) magnetic media (e.g., a magnetic disk, a tape drive, etc.; (b) optical media, (e.g., a CD-ROM, digital versatile disk (DVD), a mini-disc, etc.); and (c) semiconductor or other media (e.g., DRAM, SRAM, EPROM, EEPROM, memory stick, flash memory, etc.).

The disclosed embodiments consistent with the present invention may also include computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, intranets and the Internet (i.e., the World Wide Web). Such networks may include a wired and/or wireless network, such as, for example, a local area network (LAN), a wide area network (WAN), storage area network (SAN), a public switched telephone network (PSTN), an Integrated Services Digital Network (ISDN), an infrared (IR) link, a radio link, such as a Universal Mobile Telecommunications System (UMTS), Global System for Mobile Communications (GSM), Code Division Multiple Access (CDMA), broadcast radio network, cable television network, and a satellite link.

Further, embodiments consistent with the present invention may be implemented using various types of transmission protocols and data formats, such as, for example, transmission control protocol/internet protocol (TCP/IP), hyper text transfer protocol (HTTP), secure HTTP, wireless application protocol (WAP), hyper text markup language (HTML), extensible markup language (XML), Standard Generalized Markup Language (SGML), etc.

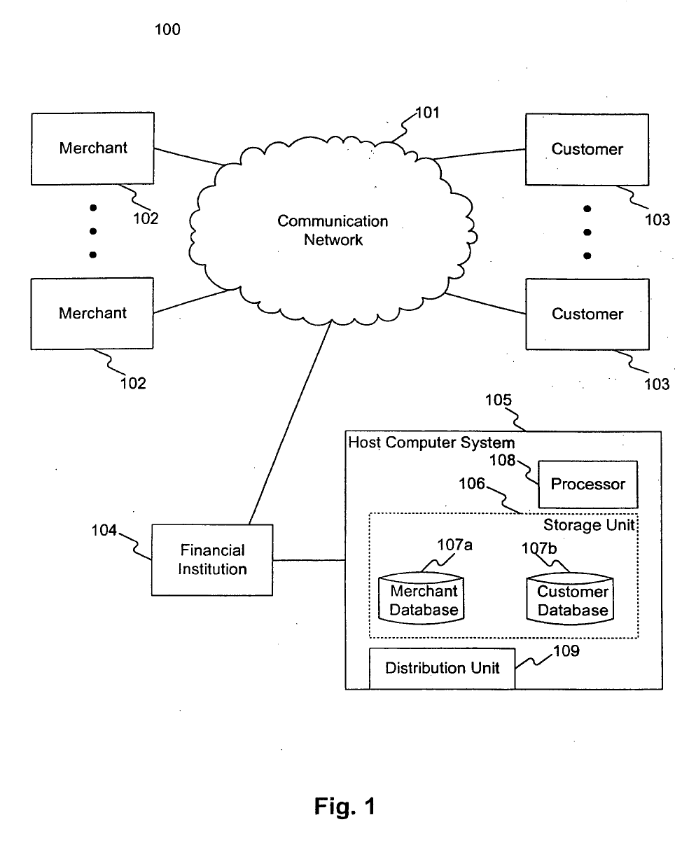

FIG. 1 illustrates an exemplary system environment 100 for implementing certain embodiments of the present invention. As shown in FIG. 1, system 100 may comprise a communication network 101, merchants 102, customers 103, financial institution 104, and host computer system 105. Communication network 101 may be a network that communicates information between elements of system environments, such as merchants 102, customers 103, and financial institution 104. In certain embodiments, communication network 101 may be a computer network, postal mail network, telephone network, a combination of networks, and any other type of network that uses wired, wireless, or other types of medium to exchange information between elements of system environment 100.

Each merchant 102 may be associated with any individual, group, or business entity that provides goods and/or services. In certain embodiments, each merchant 102 may include one or more computer systems (not shown) that process data and instructions consistent with certain embodiments of the present invention. A good may be any type of tangible or intangible item that may be sold to one or more customers 103. In an exemplary embodiment, a merchant 102 may be an automobile dealer that sells automobiles as goods to consumers, such as a customer 103. However, a “good” is not limited to any type of automobile or type of good. As such, systems and methods consistent with certain embodiments of the present invention may be associated with any types of motorized or non-motorized vehicles, such as for example, motorcycles, trailers, boats, airplanes, bicycles, etc. Other non-limiting examples of goods that may be associated with the disclosed embodiments include home appliances, electronics equipment, furniture, musical instruments, computer software, etc. A service may be any type of service that merchant 102 may provide to a consumer (e.g., a customer 103) such as warranty services, help services, replacement and repair services, and any other type of service that may be performed by merchant 102.

Customers 103 may each represent a consumer that purchases goods and/or services from one or more merchants 102. A customer 103 may also be any present or potential consumer of services provided by financial institution 104. By non-limiting example, a customer 103 can be an existing account-holder or a potential future account-holder. Further, a customer 103 may be an individual, a group of individuals, a business entity or corporation, a non-profit organization, etc. Each customer 103 may be associated with one or more computer systems, postal mailing infrastructures, telephony components, etc. that interface with communication network 101 to exchange information with merchants 102 and financial institution 104. In certain embodiments, a customer 103 may be a consumer of financial services provided by financial institution 104. For example, a customer 103 may employ financial institution 104 to purchase goods and/or services from one or more merchants 102.

Financial institution (hereinafter “FI”) 104 may reflect any individual, group, and/or business entity that provides financial services to one or more consumers, such as customers 103. For example, FI 104 may be any type of lender, such as a bank, mortgage broker, credit card provider, etc. In accordance with certain embodiments, financial institution 104 may provide one or more financial accounts for a customer 103 to purchase a good and/or service from a merchant 102. A financial account may be an account provided by FI 104 and used by customer 103 to purchase goods and/or services from a merchant 102. For instance, a financial account may be a loan, a credit card line of credit, a checking or savings account, a gift payment, or any other type of account associated with financial services for customer 103.

Host computer system 105 may be a computer system that executes program code to perform one or more processes consistent with certain embodiments of the present invention. Host computer system 105 may be configured as a single computer, such as a personal computer or server, or as a distributed computer system implemented across a number of computer devices or components, such as a computer network. Host computer system 105 may comprise any combination of servers, PCs, workstations, PDAs, laptops, cell phones, or similar devices, capable of performing the method of the claimed invention. In one embodiment, host computer system 105 may include a storage unit 106, subscription processor 108, and distribution unit 109.

Storage unit 106 may be one or more storage devices that store information associated with certain aspects of the present invention. For example, storage unit 106 may include a merchant database 107a and a customer database 107b. Although the merchant and customer databases 107a and 107b are shown as two distinct databases within storage unit 106, embodiments of the present invention are not limited to this configuration. For instance, databases 107a and 107b may be combined into a single storage unit or distributed across multiple storage units. Storage unit 106 may also include one or more processors that perform storage access and control functions for storage unit 106.

Subscription processor 108 may be one or more processors that execute program code to perform one or more processes consistent with certain embodiments of the present invention. For example, subscription processor 108 may process information stored in storage unit 106 databases to provide subscription services for one or more merchants 102.

Distribution unit 109 may be one or more communication devices that enable host computer system 105 to communicate with remote computer elements. For example, distribution unit 109 may relay information stored on host computer system 105 to a mailing center or e-mail server that may be connected to communication network 101 to coordinate the distribution of information to one or more merchants 102 and/or one or more customers. Distribution unit 109 may include software, firmware, and/or hardware configured to perform distribution tasks, such as providing information from host computer system 105. To this end, distribution unit 109 may connect directly to network 101. For instance, distribution unit 109 may include a processor that executes a computer program that manipulates a communication device (e.g., a network card). Alternatively or additionally, distribution unit 109 may execute a process that interacts with a user and provides information for distribution to a postal mail distribution center (not shown) that automatically packages and delivers mail to selected targets, such as customers 103. In certain embodiments, one or more users associated with financial institution 104 may implement host computer system 105, and distribution unit 109, to distribute information to merchants 102 and customers 103 via network 101.

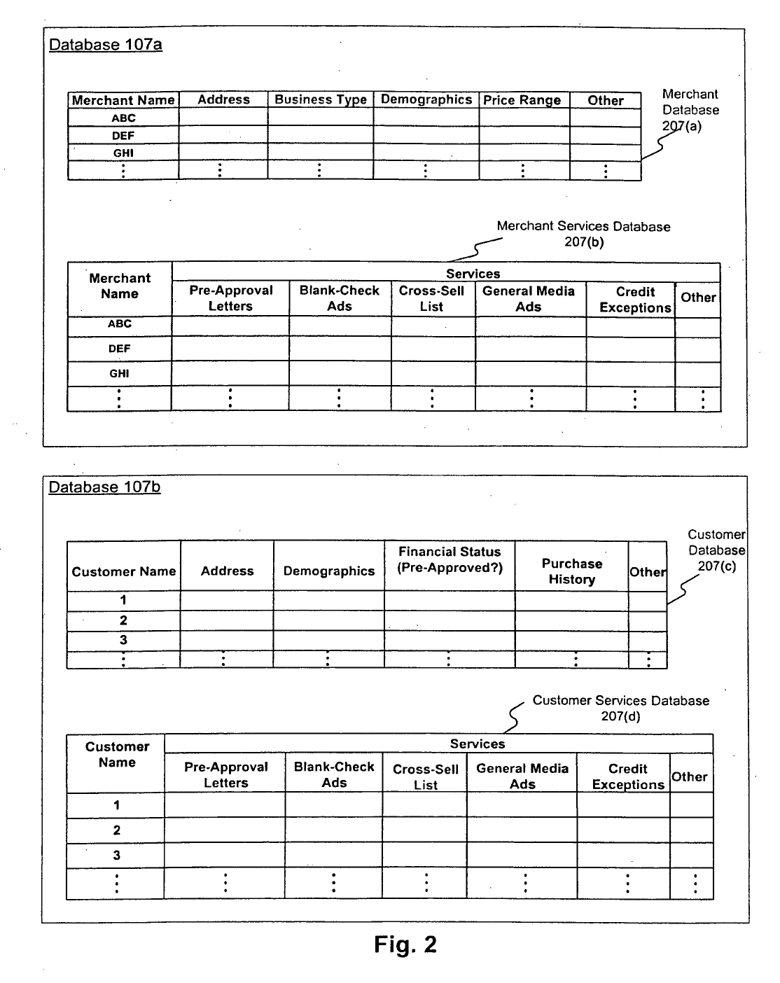

As explained, host computer system 105 includes a storage unit 106 including a merchant and customer database 107a and 107b. To better illustrate these features, FIG. 2 shows block diagrams of exemplary databases 107a and 107b consistent with certain embodiments of the present invention. As shown, merchant database 107a may include information associated with subscribing merchants 102 of FI 104. The term “subscribing merchants” refers to merchants 102 that are subscribed (e.g., registered, selected, have selected, etc.) to use the financial services of FI 104. Subscribing merchants may subscribe by paying a subscription fee to FI 104 (or an entity associated with FI 104) for using the financial services and marketing efforts offered by FI 104. For example, a subscribing merchant 102 may pay FI 104 a $25,000 fee for a 90-day subscription to use FI 104 as a source for marketing to potential customers and financing any customers that purchase goods and/or services from the subscribing merchant 102. Subscribing merchants 104 may also subscribe via other methods and/or means. For example, FI 104 may offer a free subscription to one or more merchants 102. Alternatively, a subscribing merchant 102 may execute an agreement with FI 104 for provision of financial services in return for goods and/or services provided by the subscribing merchant 102.

As shown, merchant database 107a includes a merchant database 207a and a merchant services database 207b. Merchant database 207a stores information pertinent to one or more subscribing merchants 102. For example, database 207a may store for each subscribing merchant 102, a merchant's name and address, type of business, demographic information, average price of goods, and any other type of merchant related information. Merchant services database 207b stores information pertinent to the services that each of the subscribing merchants 102 listed in database 207a receives from FI 104. For example, database 207b may include information reflecting attributes associated with the types of financial services FI 104 provides for each respective subscribing merchant 102. This information may include, for example, data associated with pre-approval letters, blank check advertisements, cross-sell lists, general media advertisements, credit exceptions, and other types of attribute information.

As shown in FIG. 2, customer database 107b may include a customer database 207c and customer services database 207d. Customer database 207c stores customer-specific information. For example, customer database 207c may store data reflecting a customer name, customer address, demographic information, customer financial status, customer purchasing history, and other type of customer-related information. In one embodiment, financial status information may include an indication of one or more loans for which the customer is pre-approved. In a preferred embodiment of the present invention, systems and methods may use the customer information to select which customers should receive advertisements promoting one or more goods and/or services offered by one or more subscribing merchants 102, and/or promoting services offered by FI 104.

Customer services database 207d is similar to merchant services database 207b in that it includes information reflecting which services are to be provided to each particular customer. In addition to selecting customers based on the information stored in customer database 207c, systems and methods consistent with certain embodiments related to the present invention may select one or more customers based on information stored in customer services database 207d.

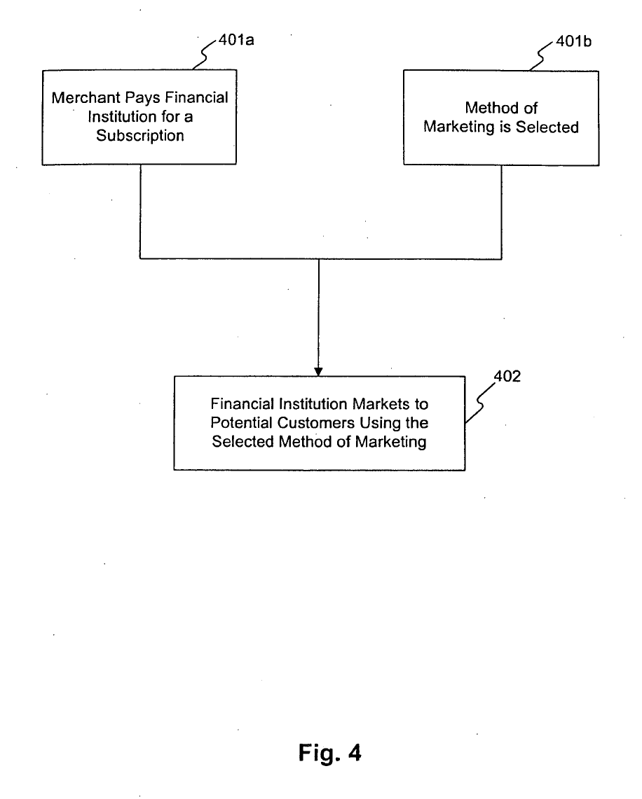

In accordance with certain embodiments, host computer system 105 may execute, at the direction of FI 104 or other entity or system, program code that matches one or more customers 103 with one or more subscribing merchants 102 based on profile data associated with the customers 103 and merchants 102. For instance, processor 108 within host computer system 105 may execute program code that matches one or more customers 103 who reside in a particular ZIP code with one or more subscribing merchants 102 that also have a place of business within the same ZIP code. As another example, processor 108 may match one or more customers 103 having a particular financial status (e.g., credit score, credit history information, salary amount, etc.) with one or more subscribing merchants 102 that provide goods and/or services target towards consumers having the same financial status (e.g., offers goods at a particular price range, etc.) Host computer system 105 may match customers 103 and merchants 102 using any type of criteria, and embodiments of the present invention are not limited to the above examples. For instance, host computer system 105 may consider demographics, business type, customer purchasing history, etc., when matching customers 103 and merchants 102. In one embodiment, processor 108 may perform the customer/merchant matching process described above based partially or wholly on information stored in the merchant services database 207b and customer services database 207d. Additional features associated with this aspect of the present invention are described below in connection with FIG. 4.

As explained, FI 104 is configured to provide one or more services to subscribing merchants 102. A merchant 102 may subscribe to receive a single service or a group of services offered by FI 104. Further, the type of service(s) received by the merchant 102 may be selected by the merchant 102, the FI 104, and/or a third party.

In an exemplary embodiment of the present invention, these services may include advertising, lending, credit, and/or other financing services. For example, FI 104 may identify and pre-approve selected customers 103 for financial accounts to purchase goods and/or services at selected subscribing merchants 102. FI 104 may generate and send pre-approval notifications promoting the selected subscription merchants 102 to the pre-approved customers 103. Through this arrangement, FI 104 offers a service by pre-approving a population of customers 104 for a particular merchant 102, which may positively affect business for both the merchant 102 and FI 104 (e.g., both FI 104 and merchant 102 receive new customers). The pre-approval notification may in the form of a letter that is mailed to the pre-approved customers 103. Alternatively, the notification may be provided via electronic communications, such as email, pager, facsimile, etc. Alternatively or additionally, FI 104 may be associated with a web server that provides a web page that is accessible by customers 103 via a computer system and communication network 101. The notification may include information indicating that a respective customer 103 is pre-approved to purchase one or more goods, for a certain amount. For example, a notification may include a statement such as “you are pre-approved to go to Bob's Auto Dealership during the month of January to get loan X to purchase goods A, B, or C.” In addition, FI 104 may generate and send blank check packages to one or more customers 103. A blank check package may include advertisements that promote a subscribing merchant 102 and a blank check issued by FI 104 that the recipient customer 103 may endorse and use to purchase goods and/or services from selected merchants 102. In another embodiment, FI 104 may also add a subscribing merchant 102 to cross-sell advertisements provided by FI 104 to a particular group of customers 103. Cross-sell advertisements advertise multiple goods and/or services to potential customers, such as insurance, loans, and other types of financial services. In addition, FI 104 may include a selected subscribing merchant 102 in its general media advertising, such as newspaper advertisements, television advertisements, advertisements published on the Internet, etc. FI 104 may also provide subscribing merchants 102 a service that handles one or more of various credit policy exceptions associated with a customer 103 (e.g., 0.00% financing for customer 103, etc.).

In accordance with certain embodiments, FI 104 may provide subscribing merchants 102 with a financial incentive to secure the financial services of FI 104 (e.g., providing financial accounts) to customers 103 who purchase goods and/or services from the subscribing merchants 102. In one embodiment, FI 104 provides monetary compensation, such as a variable or fixed commission, to subscribing merchants 102 who complete purchase transactions with customers 103 that obtain financing for the purchase transactions from FI 104.

In an exemplary embodiment, the commission may be a per-purchase-transaction payment based in part on the type of financial account used to complete the purchase transaction. For example, a subscribing merchant 102 may receive from FI 104 a $125 commission for each sale made with customers 103 based on a first type of loan, such as pre-approved loans. In another example, a subscribing merchant 102 may receive a $100 commission for each purchase transaction completed using a second type of loan and receive a $75 commission for each sale made with a third type of loan offered by FI 104. The different types of loans may comprise high-interest loans, low-interest loans, zero-interest loans, and any other type of loan offered by FI 104. In another embodiment, the commission may be a lump sum payment based on either a certain number of completed purchase transactions or a certain amount of sales revenue, or a combination of the two, accrued as a result of sales based on financial accounts offered by FI 104. In yet another embodiment, FI 104 may provide an incentive to a subscribing merchant in the form of a reduction, refund, and/or waiver of a subscription fee typically paid to FI 104 for using the services of FI 104.

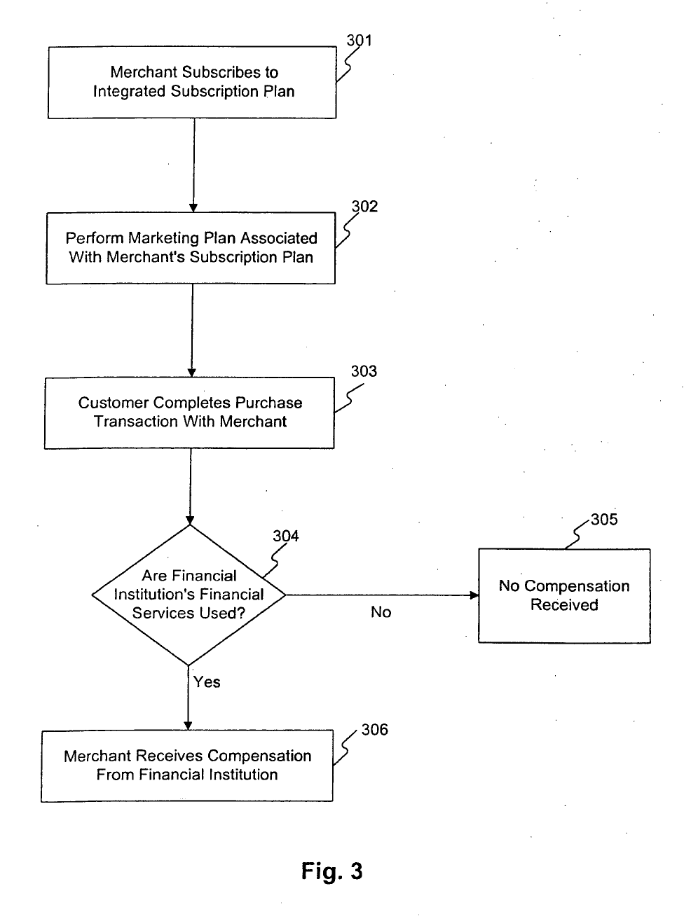

FIG. 3 illustrates a flowchart of an exemplary incentive process consistent with certain embodiments related to the present invention. At step 301, a merchant 102 subscribes to an integrated subscription plan offered by FI 104. The subscription plan may be a subscription service in which FI 104 agrees to perform one or more selected services for the merchant 102 in return for payment of a subscription fee. Alternatively, FI 104 may not charge a subscription fee to merchant 102. When subscribing to the subscription plan, merchant 102 may select the type of services (e.g., advertising, financial accounts, etc.) the merchant 102 may wish to have included in the plan. Alternatively, FI 104 may only offer certain types of service that merchant 102 by default subscribes to receive.

At step 302, FI 104 and/or host computer system 105 determines and performs a marketing plan based on the type of services included in the subscription plan subscribed to by merchant 102. A marketing plan may be performed using at least one of electronic communications (e.g., E-mail, etc.), voice communications (e.g., telemarketing, etc.), radio communications (e.g., radio advertisements, etc.), satellite communications (e.g., satellite television,), general media communications (e.g., television advertisements, etc.), and paper-based delivery communications (e.g., mail deliveries, personal deliveries, etc.), etc. In one embodiment, the marketing plan includes incentives intended to encourage customers 103 to use the financial services offered by FI 104 to purchase goods and/or services from the subscribing merchant 102. For example, consistent with the embodiments disclosed above, FI 104 may advertise one or more financial accounts to one or more customers 103 along with the goods and/or services offered by the subscribing merchant 102.

At step 303, a customer 103 completes a purchase transaction with the subscribing merchant 102 to purchase a good and/or service that is associated with the marketing plan performed by FI 104. Subscribing merchant 102 notifies FI 104 of the completed transaction using, for example, communication network 101. The purchase transaction notification may include data identifying the type of goods and/or services purchased, the purchase amount, and how the goods and/or services were purchased (e.g., financed, cash, check, etc.)

At step 304, FI 104 and/or host computer 105 determines whether the purchase transaction was financed using a financial account provided by FI 104. If not (Step 304, No), FI 104 and/or host computer system 105 may record an indication in a memory location of a storage device reflecting this condition. Subsequently, FI 104 may generate and provide a message to the subscribing merchant 102 based on the indication that no compensation will be provided to the subscribing merchant 104 (Step 305). On the other hand, if the purchase transaction was completed using a financial account offered by FI 104 (Step 304, Yes), FI 104 and/or host computer 105 may generate an indication in a memory location of a storage device reflecting this condition. Based on this indication and the integrated subscription plan associated with the subscribing merchant 102, host computer system 105 may determine the type of incentive (e.g., compensation) the subscribing merchant 102 is to receive. Subsequently, in step 306, FI 104 may provide the incentive (e.g., compensation) to the subscribing merchant 102 in a manner consistent with the merchant's subscription plan (e.g., electronic fund transfer, check, reduction in subscription fees, refund, etc.). Accordingly, in certain examples, the compensation may be in the form of a particular commission paid for the specific purchase transaction, a lump sum commission paid when the subscribing merchant exceeds a particular threshold amount of sales using FI 104 financial products, etc. Alternatively, the compensation may be a reduction, refund, or waiver of a merchant-paid fee typically paid to FI 104 for the merchant's use of FI 104's services (e.g., subscription fees).

FIG. 4 shows a flowchart of an exemplary subscription process consistent with embodiments of the present invention. In one embodiment, a merchant 102 contacts FI 104 and requests to subscribe to a subscription plan offered by FI 104. In one embodiment, the merchant 102 may pay FI 104 a subscription fee to receive services offered by FI 104 in the subscription plan (Step 401a). Additionally, the subscribing merchant 102 may also select marketing methods that may be performed by FI 104 in performing the subscription plan (Step 401b). A method of marketing may include any one or group of the marketing services discussed above (e.g. pre-approved ads, blank check ads, etc.). Further, FI 104 may offer one or more marketing method options that the subscribing merchant 102 may select (e.g., cross-sells, television advertisements, radio, mailings, or a combination of any of the these options, etc.) Also, the subscription fee may depend on the number and type of services included in the method of marketing. For example, the subscribing merchant 102 may select a method of marketing that includes sending to potential customers 103 one or more pre-approval letters that also advertise the subscribing merchant 102. The selected method may also include sending to potential customers blank check packages including advertisements that promote the subscribing merchant 102. Based on these selected marketing methods, FI 104 and/or host computer system 105 may determine the subscription fee to be paid by the subscribing merchant 102. Further, the subscribing merchant 102 may select a marketing method that designates attributes associated with a particular type of marketing. For example, the subscribing merchant 102 may be able to designate geographical ranges for implementing a marketing plan (e.g., radius range of mail deliveries, etc.)

Once the payment is made and the method of marketing is selected, FI 104 may perform the selected marketing methods to market the subscribing merchant 102 to potential customers 103 (Step 402). Thus in the above example, FI 104 may send pre-approval letters and blank check packages to certain groups of customers 103. It should be noted that FI 104 may use systems and infrastructures associated with FI 104 to perform one or more of the marketing methods. Alternatively, or additionally, FI 104 may use other systems, infrastructures, etc. associated with other entities to perform one or more of the marketing methods. For example, FI 104 may use a Web server associated with another business entity to provide marketing information to one or more potential customers 103.

In certain embodiments FI 104 and/or host computer 105 may identify customers 103 to include in a subscribing merchant's selected marketing plan based on certain criteria stored in the customer database 207c, customer services database 207d, merchant database 207a, and/or merchant services database 207b. For instance, host computer system 105 may identify one or more customers based on zip code information listed in customer services database 207d, customer database 207c, merchant database 207a, and merchant services database 207b. In this example, host computer 105 may target customers 103 that live in the same zip code as a subscribing merchant 102. The system can also select customers based on other demographics, financial status, and other types of information stored in customer and/or merchant databases 107a and 107b.

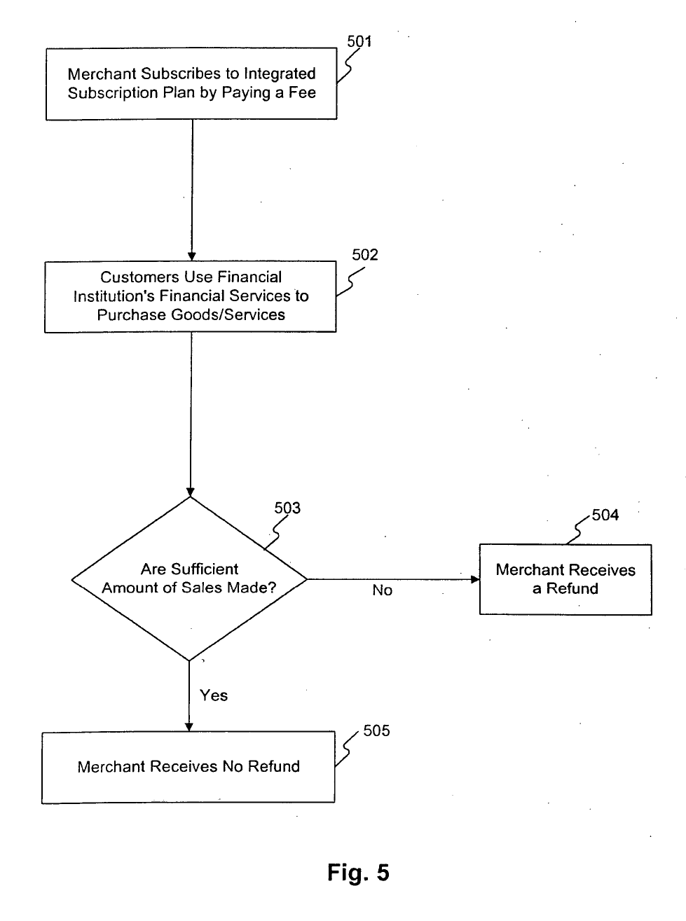

In another embodiment of the present invention, FI 104 may provide a money-back guarantee to subscribing merchants 102 based on the merchants' sales. For example, a merchant 102 that subscribes to an integrated subscription plan may have concerns that it might not make enough total sales to cover the costs of the subscription plan. For instance, a merchant 102 might pay a $25,000 fee to FI 104 for a month's subscription, but might only make enough sales to result in a maximum possible commission of $10,000, thus resulting in at least a $15,000 loss in investment. To address these concerns, the methods and systems consistent with certain embodiments of the present invention enable FI 104 to offer money-back guarantees to subscribing merchants who do not sell enough goods and/or services to cover a respective subscription fee. FIG. 5 shows a flow chart of a refund process consistent with these embodiments of the present invention.

At step 501, a merchant subscribes to an integrated services plan by paying a fee to FI 104 and selecting one or more services and marketing options for the plan. At step 502, one or more customers 103 may complete purchase transactions with the subscribing merchant 102 using financial accounts offered by FI 104. Alternatively, there may be situations in which no purchase transactions are made using a financial account offered by FI 104. The subscribing merchant 102 may provide information reflecting each purchase transaction to FI 104. FI 104 may forward this information to host computer system 105 for processing. Accordingly, at step 503, host computer system 105 system determines whether a sufficient amount of sales using an FI 104 financial account were made. The sufficient amount of sales may be based on sales volume, price, or any other factor or combination of factors. In one embodiment, host computer system 105 may determine whether a sufficient amount of sales were made based on, for example, the subscription fee paid by the subscribing merchant 102. Further, host computer system 105 may determine whether a sufficient amount of sales were made based on criteria specified in the subscription plan for the subscribing merchant 102. For example, the subscription plan may indicate that FI 104 may offer a refund to the merchant if it sells less than a certain threshold amount of goods and/or services or has less than a certain threshold amount of total sales revenue, etc. Alternatively or additionally, FI 104 may have provisions that host computer system 105 considers to determine the sufficiency of purchase transactions. For instance, FI 104 may elect to only offer a refund for reduced sales resulting from an unexpected event, such as a natural disaster or economic recession. Thus, the sufficient amount of sales described in step 503 encompasses any contemplated refund plan provided by FI 104.

If host computer 105 determines the subscribing merchant 102 has an insufficient amount of sales (step 503; No), it may provide an indication to FI 104 for offering a determined refund to the subscribing merchant. In response, FI 104 may issue a refund to the subscribing merchant (Step 504). The refund may be an amount sufficient to cover the difference or a portion of the difference between fees paid for the subscription and compensation received or receivable by the subscribing merchant. Embodiments of the present invention, however, allow for the refund to be any amount, regardless of the fees paid, and in any form, as discussed above in connection with FIG. 3 (e.g., check, electronic funds transfer, etc.).

On the other hand, if host computer system 105 determines the subscribing merchant 105 has sold sufficient goods and/or services (step 503; Yes), then host computer system 105 provides an indication to FI 104 that no refund is necessary. As a result, FI 104 does not issue a refund to the subscribing merchant 102 (Step 505).

In one embodiment, FI 104 may implement a mechanism to terminate the subscriptions of a subscribing merchant that habitually or continually fails to complete a sufficient amount of purchase transactions in accordance with the criteria disclosed above. Such mechanisms may be used in certain instances to encourage merchants 102 to use their best efforts to sell their goods and/or services using financial accounts offered by FI 104. Termination may be based on a number of consecutive merchant requests for refunds, an overall amount of sales, and/or any other relevant criteria that may be implemented by FI 104.

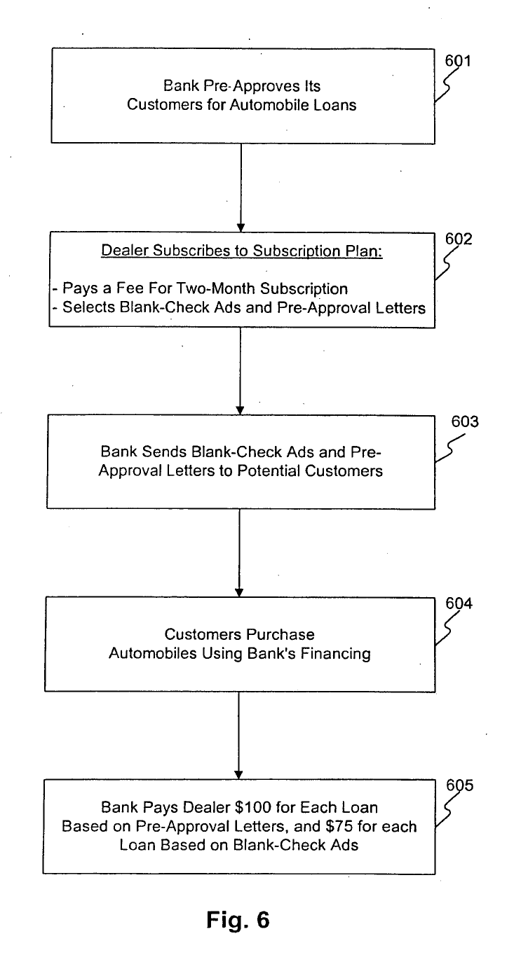

To illustrate certain features associated with the disclosed embodiments of the present invention, FIG. 6 shows a flowchart of a non-limiting exemplary incentive process associated with an automobile dealer merchant. At step 601, FI 104 and/or host computer system 105 pre-approves a first set of customers 103 for certain automobile loans. In one embodiment, a computer system may execute program code that tracks customers' accounts and financial histories. Based on this tracked information, FI 104 and/or host computer system 105 selects the first set of customers 103 for pre-approval

At step 602, the automobile dealer merchant 102 subscribes to an integrated subscription plan offered by FI 104 (e.g., a bank). In doing so, the dealer's information and plan are stored in the bank's computer system. To subscribe, the dealer merchant 102 pays a fee for a two-month subscription, and in this case selects a marketing plan to send pre-approval letters and blank-check packages including advertisements to potential customers. This information is also stored in the bank's computer system. Then, at step 603, the bank carries out the marketing plan by sending blank check packages and pre-approval letters to customers who reside within a determined distance from the dealer (e.g., ten miles radius from the dealer). In this example, the letters are sent partially by postal mail and partially by e-mail. Telephone marketing may also be employed to inform potential customers of their pre-approved status and of the dealer's automobiles.

At step 604, certain customers may purchase automobiles from the dealer using the pre-approval letters and financial accounts offered by the bank. Further, the dealer merchant 102 may also complete purchase transactions with other customers who used the blank check loans supplied by the bank.

At step 605, after confirming the purchase transactions made using financial accounts offered by the bank, the bank pays the dealer $100 for each loan obtained via one of its pre-approval letters, and $75 for each loan obtained via one of its blank checks. As noted above, in certain embodiments, FI 104 may pay a merchant 102 different commissions based on the types of financial accounts used in completing a purchase transaction. For example, a purchase transaction made using a high-interest loan, such as a loan having an interest rate higher than a market average, may warrant a $75 commission, while a low-interest loan, such as a loan having an interest rate lower than a market average, may warrant payment of a $100 commission.

Accordingly, systems and methods consistent with embodiments of the present invention provide services to merchants and customers such that they encourage the merchants to use a particular financial institution to complete certain purchase transactions. While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of embodiments of the invention being indicated by the following claims and their full scope of equivalents. Other embodiments of the invention will be apparent to those skilled in the art from consideration of the specification and practice of the invention disclosed herein.

What is claimed is:

1. A method for providing integrated subscription services, comprising:
subscribing, by a merchant, to an integrated subscription plan offered by a financial institution that provides an incentive to the merchant for using a financial service offered by the financial institution in completing purchase transactions;
marketing, by the financial institution, the merchant to one or more potential customers based on the integrated subscription plan;
completing a purchase transaction between a first customer and the merchant, wherein the first customer is included in the one or more potential customers and the purchase transaction is completed using a financial account offered by the financial institution; and
providing compensation from the financial institution to the merchant based on the completed purchase transaction.

2. The method of claim 1, wherein subscribing further comprises:
making a payment by the merchant to the financial institution; and
selecting a method of marketing to the one or more potential customers.

3. The method of claim 2, wherein the method of marketing further comprises one or more of the following:
sending, to the one or more potential customers, respective pre-approval letters for pre-approved financial accounts;
sending, to the one or more potential customers, blank check packages that include advertisements promoting the merchant;
sending, to the one or more potential customers, general media advertisements promoting the merchant; and
adding the merchant to one or more cross-sell letters provided by the financial institution.

4. The method of claim 1, wherein marketing further comprises one or more of the following:
sending, to the one or more potential customers, respective pre-approval letters for pre-approved financial accounts;
sending, to the one or more potential customers, blank check packages that include advertisements promoting the merchant;
sending, to the one or more potential customers, general media advertisements promoting the merchant; and
adding the merchant to one or more cross-sell letters provided by the financial institution.

5. The method of claim 4, wherein the marketing is performed using one or more of the following: electronic communications, voice communications, radio communications, satellite communications, and paper-based delivery communications.

6. The method of claim 1 wherein marketing further comprises selecting one or more criteria associated with the subscription and using the one or more criteria to determine the one or more potential customers.

7. The method of claim 6, wherein the one or more criteria comprise at least one of the following: a merchant location, merchant demographics, price of the merchant's goods, type of the merchant's goods, customer location, customer demographics, customer financial status, and customer purchase history.

8. The method of claim 1, wherein providing compensation further comprises at least one of:
paying a commission to the merchant, and waiving a subscription fee owed to the financial institution by the merchant.

9. The method of claim 8, wherein the commission is a fee based on one or more of the following:
a number of purchase transactions completed between the merchant and one or more customers using respective financial accounts offered by the financial institution;
an amount of sales completed by the merchant using one or more financial accounts of the financial institution;
the type of financial account offered by the financial institution and used for the completed purchase transaction, and
a method of marketing used to market the merchant to the one or more customers.

10. The method of claim 9, wherein the commission is a fee paid for each purchase transaction completed using a financial account offered by the financial institution.

11. The method of claim 9, wherein the type of financial account further comprises a type of loan.

12. The method of claim 11, wherein the type of loan further comprises at least one of a pre-approved loan, an above-average interest rate loan, a below-average interest rate loan, market interest rate loan, a zero-interest loan, and a loan obtained via a cross-sell letter.

13. The method of claim 1, wherein subscribing further comprises making a payment by the merchant to the financial institution, and wherein the financial institution guarantees to refund part or all of the payment if the merchant does not complete a threshold amount of sales in a particular time period.

14. The method of claim 13, wherein the threshold amount of sales is based on at least one of a threshold monetary value and a threshold number of purchase transactions.

15. The method of claim 1, wherein the merchant is a dealer in vehicles, the completed purchase transaction is the purchase of a vehicle, and the merchant is provided compensation from the financial institution based at least in part on the purchase of the vehicle.

16. The method of claim 1, further comprising:
subscribing, by one or more additional merchants, to one or more respective integrated subscription plans offered by the financial institution.

17. A system for integrating one or more purchase transactions by one or more customers with a merchant and a financial institution, comprising:
a host computer system;
a storage unit associated with the host computer system, the storage unit configured to store at least an indication of the merchant's subscription to an integrated subscription plan offered by the financial institution and an indication of one or more completed purchase transactions between a first customer and the merchant for one or more goods or services offered by the merchant; and
a distribution unit associated with the host computer system, the distribution unit configured to distribute marketing information from the financial institution to one or more potential customers, the marketing information marketing the merchant to the one or more potential customers,
wherein the first customer is included in the one or more potential customers and the one or more completed purchase transactions are made using one or more financial services offered by the financial institution, and
wherein compensation is provided from the financial institution to the merchant based on the one or more completed purchase transactions.

18. The system of claim 17, wherein the merchant's subscription to the integrated subscription plan offered by the financial institution further comprises:
a payment made by the merchant to the financial institution; and
a selected method of marketing to the one or more potential customers.

19. The system of claim 18, wherein the selected method of marketing further comprises one or more of the following:
sending, to the one or more potential customers, respective pre-approval letters for pre-approved financial accounts;
sending, to the one or more potential customers, blank check packages that include advertisements promoting the merchant;
sending, to the one or more potential customers, general media advertisements promoting the merchant; and
adding the merchant to one or more cross-sell letters provided by the financial institution.

20. The method of claim 17, wherein the marketing information further comprises one or more of the following:
respective pre-approval letters sent to the one or more potential customers for pre-approved financial accounts;
blank check packages sent to the one or more potential customers that include advertisements promoting the merchant;
general media advertisements promoting the merchant, sent to the one or more potential customers; and
one or more cross-sell letters provided by the financial institution that identify the merchant.

21. The system of claim 20, wherein the marketing information is distributed using one or more of the following: electronic communications, voice communications, radio communications, satellite communications, and paper-based delivery communications.

22. The system of claim 17 wherein the marketing information further comprises one or more selected criteria associated with the subscription and the host computer system uses the one or more selected criteria to determine the one or more potential customers.

23. The system of claim 22, wherein the one or more criteria comprise at least one of the following: merchant location, merchant demographics, price of the merchant's goods, type of the merchant's goods, customer location, customer demographics, customer financial status, and customer purchase history.

24. The system of claim 17, wherein the compensation further comprises at least one of:
a commission paid to the merchant, and a waiver of a subscription fee owed to the financial institution by the merchant.

25. The system of claim 24, wherein the commission is a fee based on one or more of the following:
a number of purchase transactions completed between the merchant and one or more customers using respective financial accounts offered by the financial institution;
an amount of sales completed by the merchant using one or more financial accounts of the financial institution;
the type of financial account offered by the financial institution and used for the completed purchase transaction, and
a method of marketing used to market the merchant to the one or more customers.

26. The system of claim 25, wherein the commission is a fee paid for each purchase transaction completed using a financial account offered by the financial institution.

27. The system of claim 25, wherein the type of financial account further comprises a type of loan.

28. The system of claim 27, wherein the type of loan further comprises at least one of a pre-approved loan, an above-average interest rate loan, a below-average interest rate loan, market interest rate loan, a zero-interest loan, and a loan obtained via a cross-sell letter.

29. The system of claim 17, wherein the integrated subscription plan offered by the financial institution further comprises a payment made by the merchant to the financial institution, and a guarantee by the financial institution to refund part or all of the payment if the merchant does not complete a threshold amount of sales in a particular time period.

30. The system of claim 29, wherein the threshold amount of sales is based on at least one of a threshold monetary value and a threshold number of purchase transactions.

31. The system of claim 30, wherein the merchant is a dealer in vehicles, the completed purchase transaction is the purchase of a vehicle, and the compensation provided from the financial institution to the merchant is based at least in part on the purchase of the motorized vehicle.

32. The system of claim 17, wherein the storage unit is further configured to store an indication of a subscription by one or more additional merchants to a respective integrated subscription plan offered by the financial institution.

33. A computer program product embodied in a computer-readable medium, the computer program product performing, when executed by a processor, a method for integrating one or more purchase transactions by one or more customers with a merchant and a financial institution, the computer program product further comprising:
a first program code portion executed by the processor to enable the merchant to subscribe to an integrated subscription plan offered by the financial institution;
a second program code portion executed by the processor to enable the merchant to indicate to the financial institution to market the merchant to one or more potential customers;
a third program code portion executed by the processor to indicate a completion of one or more purchase transactions between a first customer and the merchant for one or more goods or services offered by the merchant, wherein the first customer is included in the one or more potential customers, and wherein the one or more purchase transactions are made using a financial service offered by the financial institution; and
a fourth program code portion executed by the processor to enable the financial institution to provide compensation to the merchant based on the one or more completed purchase transactions.
